(19) United States
(12) Patent Application Publication
(10) Pub. No.: US 2012/0192575 A1
(43) Pub. Date: Aug. 2, 2012

(54) ICE MACHINE SAFE MODE FREEZE AND HARVEST CONTROL AND METHOD

(75) Inventors: Ramesh B. Tirumala, Lutz, FL (US); William Roy York, JR., Maintowoc, WI (US); Lee Gerard Mueller, Kewaunee, WI (US); Raymond R. Haack, Mishicot, WI (US); Daryl G. Erbs, Sheboygan, WI (US)

(73) Assignee: MANITOWOC FOODSERVICE COMPANIES, LLC.

(21) Appl. No.: 13/362,659

(22) Filed: Jan. 31, 2012

Related U.S. Application Data
(60) Provisional application No. 61/438,189, filed on Jan. 31, 2011.

(51) Int. Cl. F25B 49/00; F25C 1/00; G05D 23/32

(52) U.S. Cl. 62/66; 62/132; 62/129; 62/126; 62/157

(57) ABSTRACT

A controller continues to operate an ice making machine in a safe mode when a failure of a component is detected. While in the safe mode due to failure of an ice thickness probe, the freeze cycle freeze time is based on an average freeze time of a predetermined number of the most previous freeze cycles prior to the failure. While in the safe mode due to failure of a water level probe, the water valve on time is based on an average water valve on time of a predetermined number of the most previous freeze cycles prior to the failure. If the failure is uncured after a predetermined time, the controller causes the ice making machine to enter a standby mode or disables the ice making machine from making ice.

### RELATED APPLICATION

This application claims priority to U.S. Provisional Application, Ser. No. 61/438,189, filed on Jan. 31, 2011, the entire contents of which are incorporated herein.

### FIELD OF THE DISCLOSURE

This disclosure relates to an ice machine and method and, in particular, to an ice machine and method that allows the ice machine to operate for a period of time in the event of a failure of a component until a service person arrives to repair the failed component.

### BACKGROUND OF THE DISCLOSURE

A typical ice making machine includes a controller that collects information from various components during normal operation. The components include an ice thickness probe, a water level probe, a thermistor/thermocouple, an accessory bin level sensor, a user interface, one or more refrigerant pressure sensors and other components. The ice thickness probe measures the thickness of the ice forming on an ice making surface of the evaporator. The water level probe is used to control the amount of water residing in a sump/trough to provide the correct water quantity for making a batch of ice. The thermistor or thermocouple senses temperatures in the refrigeration system including but not limited to refrigerant liquid line, compressor discharge, inlet to evaporator, evaporator outlet. The bin level sensor is used to measure the amount of ice in a bin storage area. The user interface includes a keypad by which a user may enter information. The refrigerant pressure sensors detect refrigerant pressure at various locations in the refrigeration system. Should one of these components fail, the typical ice making machine shuts down. The owner is forced to acquire ice from another source until service personnel can arrive and repair the ice making machine.

There is a need for an ability to continue ice making in the event of failure of certain components to avoid procurement from another source.

### SUMMARY OF THE DISCLOSURE

An embodiment of an ice making machine of the present disclosure comprises an ice making apparatus that comprises a plurality of components and a controller. The controller in a normal mode controls the components to make ice using a freeze cycle and a harvest cycle. In the event of a detection of failure of a first component, a second component and or both the first component and the second component of the plurality of components, the controller continues in a safe mode to make ice using the freeze cycle and the harvest cycle by using historical information recorded during the normal mode.

In another embodiment of the ice making machine of the present disclosure, the first component and the second component are selected from the group consisting of: ice thickness probe and water level probe.

In another embodiment of the ice making machine of the present disclosure, the first and second components are an ice thickness probe and a water level probe, respectively, and wherein the historical information comprises a most recent average freeze cycle time value and a most recent average water valve inlet on time value based on a predetermined number of the most recent freeze cycles.

In another embodiment of the ice making machine of the present disclosure, the controller in the safe mode executes all subsequent freeze cycles after the detection of failure using:
if the ice thickness probe, the most recent average freeze cycle time prior to the detection of failure,
if the water level probe, the most recent average water inlet valve on time value, and
if both the ice thickness probe and water level probe, the most recent average values for both the water inlet valve and the freeze cycle time.

In another embodiment of the ice making machine of the present disclosure, the controller exits the safe mode if the failure remains uncured at a predetermined time after the failure is detected.

In another embodiment of the ice making machine of the present disclosure, the controller upon exiting the safe mode enters a standby mode or disables the ice making machine.

In another embodiment of the ice making machine of the present disclosure, the controller while in safe mode posts an alert on a user interface.

In another embodiment of the ice making machine of the present disclosure, the controller comprises a processor and a memory in which is stored one or more programs comprising instructions for the normal mode and the safe mode. The processor executes the instructions to perform operations comprising:

starting a timer that measures a time duration for the safe mode;

continuing to make ice as in the normal mode using the historical information;

if the failure is cured before the time duration ends, returning to the normal mode; and

if the failure still exists when the time duration ends, disabling the ice machine or entering a standby mode.

In another embodiment of the ice making machine of the present disclosure, the operations further comprise posting an alert on a user interface.

In another embodiment of the ice making machine of the present disclosure, the operations further comprise sending notice of the failure to a servicer.

In another embodiment of the ice making machine of the present disclosure, the operations further comprise continuing to execute the freeze cycles and the harvest cycles in the safe mode until the time duration ends or the failure is cured.

An embodiment of the method of the present disclosure operates an ice making machine that comprises a plurality of components and a controller by:

controlling the components in a normal mode to make ice using a freeze cycle and a harvest cycle, and

in the event of a detection of failure of a first component, a second component and or both the first component and the second component of the plurality of components, continuing in a safe mode to make ice using the freeze cycle and the harvest cycle by using historical information recorded during the normal mode.

In another embodiment of the method of the present disclosure, the first and second components are an ice thickness probe and a water level probe, respectively. The historical information comprises a most recent average freeze cycle time value and a most recent average water valve inlet on time value based on a predetermined number of the most recent freeze cycles.

In another embodiment of the method of the present disclosure, the controller comprises a processor and a memory in which is stored one or more programs comprising instructions for the normal mode and the safe mode. The method further comprises executing with the processor the instructions to perform steps comprising:

starting a timer that measures a time duration for the safe mode;

continuing to make ice as in the normal mode using the historical information;

if the failure is cured before the time duration ends, returning to the normal mode; and

if the failure still exists when the time duration ends, disabling the ice machine or entering a standby mode.

In another embodiment of the method of the present disclosure, the method further comprises posting an alert on a user interface.

In another embodiment of the method of the present disclosure, the method further comprises sending notice of the failure to a servicer.

In another embodiment of the method of the present disclosure, the method further comprises continuing to execute the freeze cycles and the harvest cycles in the safe mode until the time duration ends or the failure is cured.

### BRIEF DESCRIPTION OF THE DRAWINGS

Other and further objects, advantages and features of the present disclosure will be understood by reference to the following specification in conjunction with the accompanying drawings, in which like reference characters denote like elements of structure and:

FIG. 1 is a block diagram of an ice making machine of the present disclosure;

FIG. 2 is a block diagram of the controller of the ice making machine of FIG. 1; and

FIG. 3 is a flow diagram of the safe mode of the controller of FIG. 2.

### DESCRIPTION OF THE PREFERRED EMBODIMENT

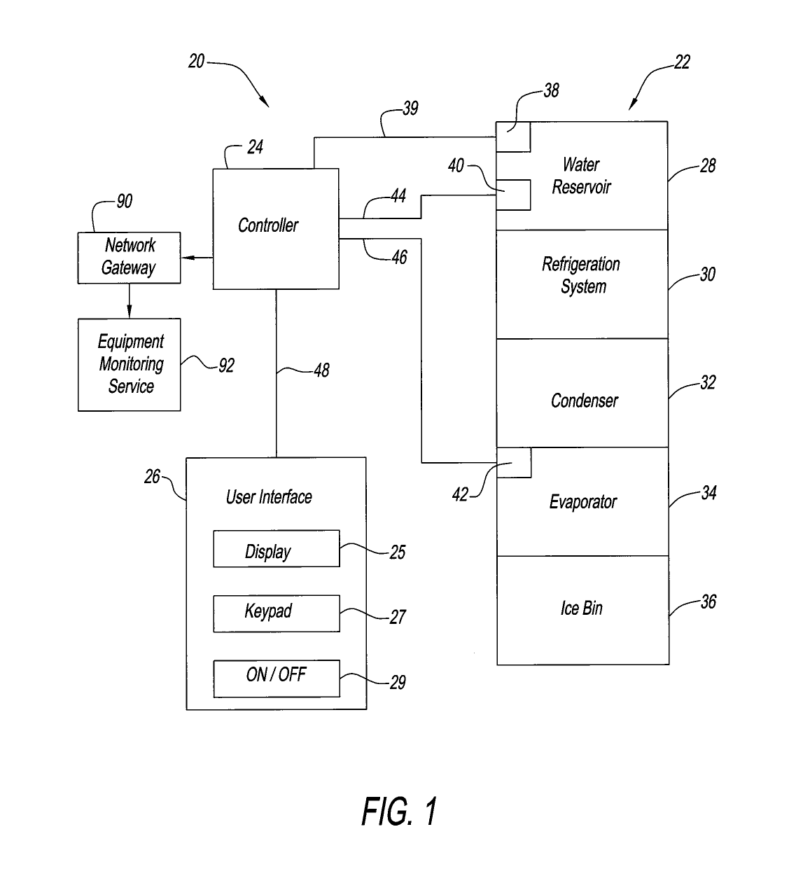

Referring to FIG. 1, an ice making machine 20 comprises an ice making apparatus 22, a controller 24 and a user interface 26. Ice making apparatus 22 comprises a water reservoir (or sump) 28, a refrigeration system 30, a condenser 32, an evaporator 34 and an ice bin 36. Refrigeration system 30 is in fluid communication with condenser 32 and evaporator 34 to provide refrigerant flow during a freeze cycle and hot gas flow during a harvest cycle. During the freeze cycle water is supplied from water reservoir 28 to an ice making surface of evaporator 34, which is cooled by the refrigerant flow to grow ice on the ice making surface. During the harvest cycle the ice making surface is warmed by the hot gas flow to loosen the ice from the ice making surface so that it falls into ice bin 36.

Controller 24 controls the freeze cycle and harvest cycle through connections to various components of ice making machine 22. These components include a water inlet valve 38, a water level probe (WLP) 40, an ice thickness probe (ITP) 42 and others that are not shown in the drawing. Water inlet valve 38 is located to supply water from a water source (not shown) to water reservoir 28 and is connected in electrical circuit with controller 24 via a connection 39. Water level probe 40 is located in water reservoir 28 and is connected in electrical circuit with controller 24 via a connection 44. Ice thickness probe 42 is located in evaporator 34 and is connected in electrical circuit with controller 24 via a connection 46. Another connection 48 connects controller 24 with user interface 26. Each of these connections may include one or more separate conductors.

User interface 26 comprises a display 25, a keypad 27 (or other user entry device) and an ON/OFF switch 29.

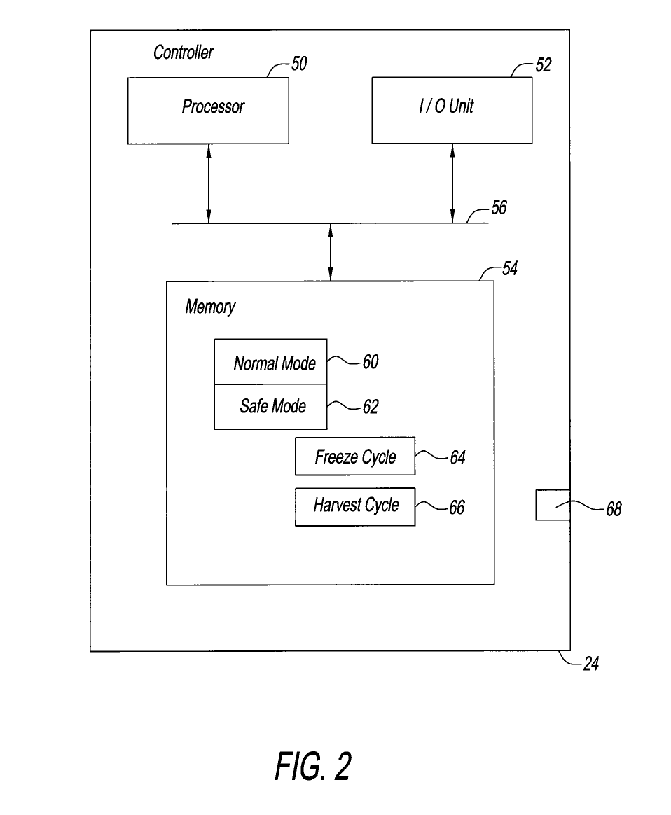

Referring to FIG. 2, controller 24 comprises a processor 50, a memory 52 and an input/output (I/O) unit 54 that are interconnected by a bus 56. A normal mode program 60, a safe mode program 62, a freeze cycle program 64 and a harvest cycle program 66 are stored in memory 54 together with other programs (not shown) needed for processor 50 (e.g., an operating system and utility programs) and for the operation of ice making apparatus 22. Memory 54 may be any suitable memory, such as, a random access memory, a read only memory, a plug-in memory (e.g., a flash memory, a disk memory or other plug-in memory) and/or any combination thereof. The plug-in memory may be plugged into controller 24, for example, via a UBS port 68.

I/O unit 52 includes connections with ice making apparatus 22 and user interface 26. These connections include connections 39, 44, 46 and 48 (FIG. 1) as well as other connections (not shown).

Processor 50 is operable to execute normal mode program 60, safe mode program 62, freeze cycle program 64 and harvest cycle program 66 to control the operation of ice making apparatus 22 to make ice and to collect information concerning its operation. Normal mode program 60, freeze cycle program 64 and harvest cycle program 66 may be any suitable programs known presently or in the future.

Processor 50 collects and averages the freeze cycle times and sump water fill times over a predetermined number X of the most previous freeze cycles. For example, in one embodiment the predetermined number is five. At the start of each freeze cycle 64, processor 50 begins timing the sump water fill time and freeze cycle time. Sump water fill time is the total time water inlet valve 38 is energized for each freeze cycle. Freeze cycle time begins with the start of water being supplied to the ice making surface of evaporator 34 and ends when ITP 42 signals that the ice slab has reached a thickness where the ice can be harvested as one slab. Processor 50 initiates execution of harvest cycle 66, records the freeze cycle time and updates the average freeze cycle time and the average sump water fill time (or water inlet valve on time) in memory 54. The average freeze cycle time and the average water inlet time recorded during the normal mode comprises historical information.

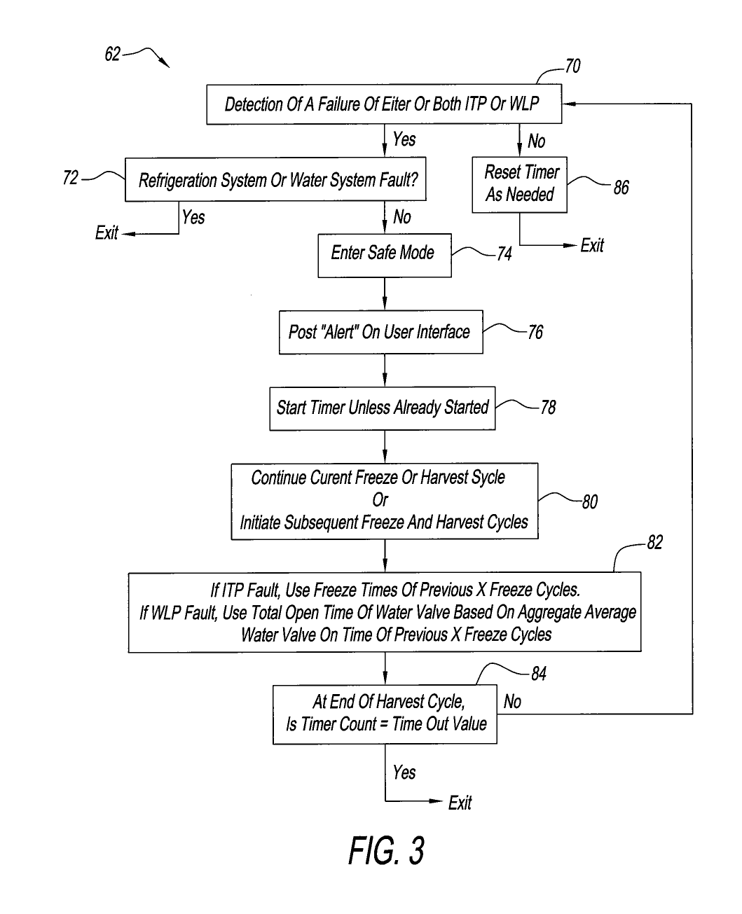

Referring to FIGS. 2 and 3, processor 50 executes safe mode program 62 by periodically checking for a detected failure of either or both WLP 40 or ITP 42 as reflected at box 70. A WLP fault signal is conveyed from WLP 40 via connection 44 to controller 24. An ITP fault signal is conveyed from ITP 42 via connection 46 to controller 24. If no fault is detected, processor 50 exits safe mode program 62. If a default is detected, processor 50 at box 72 determines if there is a fault or failure of the refrigeration system 30 or the water system. If yes, processor 50 exits safe mode program 64. If no, processor 50 continues execution of safe mode program 62 as indicated at box 74. At box 76, processor 50 causes an alert to be posted at a suitable location on user interface 26, for example, display 25.

At box 78 processor 50 starts a timer for measuring the time that controller 24 is operating in safe mode program 62 unless already started, e.g., during a previous safe mode freeze cycle. At box 80 processor 50 continues a currently running freeze cycle program 64 or harvest cycle program 66. If none is currently running, processor 50 initiates execution of freeze cycle program 64 in the normal course of ice making. For example, execution of freeze cycle program 62 will be initiated when a bin level sensor (not shown) of ice bin 36 signals that the level of ice in ice bin 36 has reached a level that requires more ice.

In the event processor 50 recognizes a failed WLP, at the start of each subsequent freeze cycle water inlet valve 38 is opened for the most recent average sump fill time prior to the detection (historical information). The freeze cycle is then executed and terminates based on the ice thickness detection by ITP 42.

In the event processor 50 recognizes both a failed WLP and a failed ITP, the most recent average values prior to detection for both sump fill time and freeze cycle time (historical information) are used for controlling the opening of water inlet valve 38 and the time duration (freeze cycle time) until harvest is initiated.

At box 82 if an ITP fault, processor 50 uses as freeze cycle time an average freeze cycle time based on the most previous X freeze cycles prior to detection of the ITP fault. If a WLP fault, processor 50 uses a total open time of water inlet valve 38 of water reservoir 28 based on an aggregate average water inlet valve 38 on time of the most previous X freeze cycles (historical information) prior to detection of the WLP fault.

At box 84 when execution of harvest cycle program 66 ends, processor 50 determines if the timer count is equal to a time out value. If yes, processor 50 exits safe mode program 62. For example, processor 50 may enter a standby mode or even disable ice making machine 20. If no, execution continues at box 70. If a fault is again detected, the program execution continues to the succeeding boxes. If no, processor 50 at box 86 resets the timer as needed and then exits and returns to execution of normal mode program 60.

A further embodiment of the disclosure automatically provides notice of the fault to the servicer. This is accomplished by a network gateway 90 from controller 24 to an equipment monitoring service (call center) 92 as shown in FIG. 1. Equipment monitoring service 92 then contacts a local servicer to service the machine.

During the safe mode, controller 24 continues to monitor the operating safeties and other diagnostic functions and will shut down to protect ice making machine 20 if necessary.

Ice making machine 20 has the advantage of being able to continue to operate (make ice) should either ITP or WLP fail. In addition, the operator is notified of the failure with enough notice to notify a servicer before running out of ice.

The present disclosure having been thus described with particular reference to the preferred forms thereof, it will be obvious that various changes and modifications may be made therein without departing from the spirit and scope of the present disclosure as defined in the appended claims.

What is claimed is:

1. An ice making machine comprising:
an ice making apparatus that comprises a plurality of components; and
a controller that in a normal mode controls said components to make ice using a freeze cycle and a harvest cycle, and that, in the event of a detection of failure of a first component, a second component and or both said first component and said second component of said plurality of components, continues in a safe mode to make ice using said freeze cycle and said harvest cycle by using historical information recorded during said normal mode.

2. The ice making machine of claim 1, wherein said first component and said second component are selected from the group consisting of: ice thickness probe and water level probe.

3. The ice making machine of claim 1, wherein said first and second components are an ice thickness probe and a water level probe, respectively, and wherein said historical information comprises a most recent average freeze cycle time value and a most recent average water valve inlet on time value based on a predetermined number of the most recent freeze cycles.

4. The ice making machine of claim 3, wherein said controller in said safe mode executes all subsequent freeze cycles after said detection of failure using:
if said ice thickness probe, said most recent average freeze cycle time prior to said detection of failure,
if said water level probe, said most recent average water inlet valve on time value, and
if both said ice thickness probe and water level probe, said most recent average values for both said water inlet valve and said freeze cycle time.

5. The ice making machine of claim 1, wherein said controller exits said safe mode if said failure remains uncured at a predetermined time after said failure is detected.

6. The ice making machine of claim 1, wherein said controller upon exiting said safe mode enters a standby mode or disables said ice making machine.

7. The ice making machine of claim 1, wherein said controller while in safe mode posts an alert on a user interface.

8. The ice making machine of claim 3, wherein said controller comprises a processor and a memory in which is stored one or more programs comprising instructions for said normal mode and said safe mode, and wherein said processor executes said instructions to perform operations comprising:
starting a timer that measures a time duration for said safe mode;
continuing to make ice as in said normal mode using said historical information;
if said failure is cured before said time duration ends, returning to said normal mode; and
if said failure still exists when said time duration ends, disabling said ice machine or entering a standby mode.

9. The ice making machine of claim 8, wherein said operations further comprise posting an alert on a user interface.

10. The ice making machine of claim 8, wherein said operations further comprise sending notice of said failure to a servicer.

11. The ice making machine of claim 8, wherein said operations further comprise continuing to execute said freeze cycles and said harvest cycles in said safe mode until said time duration ends or said failure is cured.

12. A method of operating an ice making machine that comprises a plurality of components and a controller, said method comprising:
controlling said components in a normal mode to make ice using a freeze cycle and a harvest cycle, and
in the event of a detection of failure of a first component, a second component and or both said first component and said second component of said plurality of components, continuing in a safe mode to make ice using said freeze cycle and said harvest cycle by using historical information recorded during said normal mode.

13. The method of claim 12, wherein said first and second components are an ice thickness probe and a water level probe, respectively, and wherein said historical information comprises a most recent average freeze cycle time value and a most recent average water valve inlet on time value based on a predetermined number of the most recent freeze cycles.

14. The method of claim 13, wherein said controller comprises a processor and a memory in which is stored one or more programs comprising instructions for said normal mode and said safe mode, and further comprising:
executing with said processor said instructions to perform steps comprising:
starting a timer that measures a time duration for said safe mode;
continuing to make ice as in said normal mode using said historical information;
if said failure is cured before said time duration ends, returning to said normal mode; and
if said failure still exists when said time duration ends, disabling said ice machine or entering a standby mode.

15. The method of claim 14, further comprising posting an alert on a user interface.

16. The method of claim 14, further comprising sending notice of said failure to a servicer.

17. The method of claim 14, further comprising continuing to execute said freeze cycles and said harvest cycles in said safe mode until said time duration ends or said failure is cured.
